(19) United States
(12) Patent Application Publication
(10) Pub. No.: US 2015/0145704 A1
(43) Pub. Date: May 28, 2015

(54) METHOD AND SYSTEM FOR REAL TIME DISPLAYING OF VARIOUS COMBINATIONS OF SELECTED MULTIPLE AIRCRAFTS POSITION AND THEIR COCKPIT VIEW

(71) Applicant: Pinchas Dahan, Alfi Menashe (IL)

(72) Inventor: Pinchas Dahan, Alfi Menashe (IL)

(21) Appl. No.: 14/397,231

(22) PCT Filed: May 2, 2013
(86) PCT No.: PCT/IL2013/000045

§ 371 Date: Oct. 27, 2014

(30) Foreign Application Priority Data
May 3, 2012 (IL) 219572

(51) Int. Cl. B64D 43/02

(52) U.S. Cl. CPC B64D 43/02
USPC 340/971

(57) ABSTRACT

The present invention relates to a method and system for displaying multiple aircrafts positions in a display system for real-time monitoring flights. The method will enables the trainer in the ground station, to select and to switch between aircrafts to monitor the flight at real time as if he were next to the selected trainee and to see the instruments panel and also the three dimensional positions of the respective aircraft as seen from the cockpit and to conduct a conversation with the pilot. The method enable to give to the trainee the needed instructions to overcome problem he might face during flight and to displays a warning mark when a distance between two aircraft is shorter than a threshold value and. The method enables data transmission based on a cellular internet communication.

### FIELD OF THE INVENTION

The present invention relates to transmission of acquired data and a method for display, in particular for multiple vehicles, and in application for aircrafts wherein the acquired data is includes instrument panel data, navigation data and audio data.

### BACKGROUND OF THE INVENTION

The present invention pertains to a method for data acquisition, monitoring and display systems of a variety of instruments and the terrain of an air space under air traffic control, displays aircraft marks at positions on the display screen so as to correspond to the three dimensional positions of the respective aircrafts, wherein acquisition of digital data directly from an instrument or a display may be complex or difficult. As an example the invention might be implemented for small aircrafts with trainees flights that will enables the trainer who is not in the aircraft, to monitor the flight at real time as if he were next to the trainee and give him the needed instructions to overcome problem he might face during flight.

Thus over through this document the data acquisition, monitoring and display systems is described for small aircraft.

A trainee performing solo flights may perform errors, which may lead to sever accidents as there is no trainer who can correct the mistakes he made. In addition, after the flight the trainer cannot point exactly to the errors occurred during the flight. Sending the video image to the ground is possible using a video camera. It is however relatively very expensive because the bandwidth requirements for obtaining the necessary resolution of all the gauges on the panel instrument becomes prohibitive.

Connecting directly to the analogue gauges on the other hand—is very complicated.

The main challenge of the system should be a real-time monitoring of the flight that will enables the trainer who is not in the aircraft, to monitor the flight at real time—as if he were next to the trainee and to see also the three dimensional positions of the respective aircraft as seen from the cockpit and to displays a warning mark when a distance between two aircraft is shorter than a threshold value and give him the needed instructions to overcome problem he might face during flight.

In U.S. Pat. No. 2007/0236366, data acquisition and display systems were provided in particularly for small aircraft. In the overview of this publication the prior art status with their disadvantages are described. The disadvantage are due to various reason such as:

In paragraph [0003], “Telemetry systems are also known for transmitting such data from a vehicle to a ground station. However, for small aircraft including trainer aircraft, such systems may carry a cost element of the order of the cost of the aircraft itself, which deters use thereof in such applications.”

In paragraph [0009]“Taking images of the instrument panel according to the prior art, as has been discussed above, in practice requires high resolution, and in order to transmit this data very wide bandwidths are required, higher than 5 MHz. Radio transmission equipment required for such wide band transmission is typically expensive, as is the actual transmission channel that is required.”

In paragraph [0010]“Similar problems are encountered when desiring to transmit video images of the scenery outside the aircraft, for example as seen by the pilot-Either full bandwidth is required according to the prior art, . . . . ”

In U.S. Pat. No. 2007/0236366 the proposed method is based on analyzing the reading of the gauges in the panel instrument of the aircraft and send very low bandwidth information via RF MODEM to the ground. The solution was to perform image-processing algorithms on the video from one camera or two cameras situated in the cockpits, and transmit the numerical value of each of the gauges to the ground. The transmission of numerical results in 8 & 16 bits imposes a bandwidth of 9,600 bits per second. The channel is an RF radio modem, which results in a relatively inexpensive system. The trainer watching the Ground Station (GS) sees the same view as the trainee.

However, in U.S. Pat. No. 2007/0236366 the provided method display only single aircraft position, and thus avoiding the occurrence of near miss or collision of the trainer aircraft with other aircraft. In addition, during the flight or after the flight the trainer cannot point exactly to the errors occurred during the flight corresponding to the real situation that includes other aircrafts in the terrain of an air space as seen by the trainee i.e. in its field view.

In addition the disadvantage in the method proposed in U.S. Pat. No. 2007/0236366 is relating to the transmitter required for data transmission from the aircraft. The transmission of the numerical results was proposed to be based on an RF radio modem in addition to the existing audio RF modem in the aircraft. This method is relatively expensive and is limited in its transmission distance. This method is also requiring high power transmitter which require connecting the transmitter directly to the aircraft power supply which is very complicated.

The present invention provides a method for acquiring data from multiple aircrafts and displaying their positions, and their travel direction and also to provide to the trainer in the GS to see the same view as the trainee sees including the 3D view of the aircrafts positions as seen within the field of view of the trainee in the cockpit.

The data transmission and receiving is based on either (a) a cellular communication (b) a cellular internet communication which is on one hand is unlimited in its transmission distance and on the other hand require very low power supply.

### THE DRAWINGS

FIG. 1: is a block diagram illustrating the system for real time displaying of various combinations of selected multiple aircrafts positions and their cockpit view

FIG. 2: shows the system 100 for acquisition and analyzing data of the instruments panel and the position of the air craft.

FIG. 3: shows the splitting encoded data 210 and the analyzing data system 230.

FIG. 4: shows the aircrafts control display system 320 which collects the whole data relating to all aircrafts in the air under control.

FIG. 5: shows the aircrafts control display unit 320 used for existing Flight Simulator 800 which may be adapted in the following manner FIG. 6, show as an example a combination selected by the trainer using 360 unit to be displayed in the screen 310.

FIG. 6: show as an example a combination selected by the trainer using 360 unit to be displayed in the screen 310.

FIG. 7: show as an example a combination selected by the trainer using 360 unit to be displayed in the screen 310.

FIG. 8: show as an example a combination selected by the trainer using 360 unit to be displayed in the screen 310.

### THE INVENTION

It is a first object of the present invention to provide a method for acquiring data from the aircrafts and displaying their positions, which is capable of effectively avoiding the occurrence of near miss or collision. The terrain of an air space under air traffic control apparently displayed in three dimensions on a display screen, with the aircrafts positions marked on the display screen so as to correspond to the three dimensional positions of the respective aircraft, and provides a warning mark when a distance between two aircraft is shorter than a threshold value.

It is a second object of the present invention to provide a method for the numerical data transmission and receiving. In the aircraft the data transceiver is based on a cellular mean which is on one hand is unlimited in its transmission distance and on the other hand require very low power supply and thus ebable the communication to work on an independent power supply. In the ground station the data transceiver is based on either (a) a cellular mean; (b) an internet communication, communicate with the cellular in the aircraft, which is enable the ground station to be at several different places. The later possibility will be denoted as a “cellular internet communication” while the former possibility will be denoted as a “cellular communication”.

According to a third aspect of the present invention, the method according to the first aspect is characterized in that the aircrafts position, their travel directions and their ground speeds are indicated by vectors based on travel direction data and ground speed data contained in the transmitted data acquired directly from the reconstructed panel instruments of the aircrafts.

It is a fourth object of the present invention to provide to the trainer in the GS to see the same view as the trainee sees including the 3D view of the aircrafts positions as seen within the field of view of the trainee in the cockpit.

It is a fifth object of the present invention to provide to the trainer in the GS to see the same view as the trainee sees including the 3D view of the aircrafts positions as seen within the backward field of view of the trainee in the cockpit.

It is a sixth object of the present invention to provide to the trainer in the GS to see in the real time the same view as the trainee sees including the 3D view of the aircrafts positions and the instrumental panel of the aircraft. Thus the main advantage of this system is the ability to monitor safety the flight in real-time with the real view seen by the trainee of both the air space and the instruments panel.

According to the seventh aspect of the present invention, the method according to the fifth aspect is particularly adapted for use with an aircraft for the purpose of student training, in particular to provide real-time flight information to an instructor in a ground station, and optionally for assisting the pilot in flight preparation and/or in debriefing the pilot after flight.

In order to attain the objects of the present invention, the data communication is performed by using either a “cellular communication” or a “cellular internet communication”. The numerical data captured by the cameras in the aircraft such as data from panel instruments and other relevant data is transmitted through mobile communication to the ground station which received the data through internet or cellular means.

The advantages of using “cellular internet communication” are: The GPS is communicates with the cockpit computer system (data processing system) via an RS-232. The GPS sends data either in ASCII or binary. The cockpit computer system samples streaming video and sends numerical data to the GS. Size of a frame of a streaming video is 1-2M bytes (depending on the resolution etc. We sample 15-24 frames per second.

The total video size is 15-48 Mega per second. The aircraft has no more than 50 meters and we send numerical data for every meter. Each datum is represented in 4 bytes (floating point number). In addition, we use 6 positional data where each of them is represented in 4 bytes. Thus the total avionic state results in 54 numerical data which needs 216 bytes. For 15-24 updates in a second we need 3,240-5.184 Bytes per second. The compression ratio from video to numerical is by a factor of about 5000. According to the present invention the data communication is performed by using a “cellular communication” or a “cellular internet communication”. While transmitting the panel instruments as a video data require 5.4 GB up to 17.28 GB the numerical transmission according to the method described in U.S. Pat. No. 2007/0236366, only 11.66 MB up to 18.662 Mb should be transmitted. In addition the communication via the cellular to the internet, give the use the ability to monitor flights in any place like home.

The ground station is comprises a terrain in three dimensions or two dimensions on a display system. The flight profile may be set up, using a “software package for displaying” it to see the instruments panel as seen by the trainee in the cockpit and to see the topographic view and the positions of the respective aircraft as seen by the trainee from the cockpit, where the “software package for displaying” may be an of the shelf such as a flight simulator available in the market, using data such as navigation course, altitude and speed, and the flight simulator can be used to run the flight profile and automatically display the scenery outside the cockpit window and the instrument readings of the flight profile.

Alternatively the data corresponding to each air craft in the air space under air traffic control; finding three-dimensional positions of aircrafts based on position data and altitude data of the respective aircrafts with the reconstructed data contained in the received panel instruments.

Then displayed 3D position of the aircrafts marked on the screen indicating the respective inter distance of aircrafts. So warning is possible by finding an inter-distance between two neighboring aircraft, and determining whether the distance found is shorter than a threshold value.

In order to attain the above mentioned objects, according to all aspects of the present invention, the method comprises:

1) The data communication is performed by using either a “cellular communication” or a “cellular internet communication”. The numerical data captured by the cameras in the aircraft such as data from panel instruments and other relevant data is transmitted through mobile communication to the ground station which received the data through internet or cellular means.
2) Displaying a terrain apparently using a “software package for displaying” or a flight simulators available in the market, or displaying a three dimensions on a display screen based on topographic data corresponding to an air space under air traffic control.
3) Performing an image-processing on the video from one, two or more cameras situated in the cockpits, and transmits the numerical value of each of the gauges and other televant data to the ground station using moibile communication. Alternatively a very low bandwidth RF modem might be used.
4) In the GS the received numerical value of each of the gauges is analyzed and the same gauges in the panel instrument of the aircraft is reconstructed so the display in GS sees in real time the same panel instrument view as the trainee. The reconstructed panel instrument view of each of the aircrafts corresponding to an air space under air traffic control is simultaneously displayed on the GS screen.
5) Finding three dimensional positions of respective aircrafts based on position data and altitude data of the respective aircraft obtained from data of the reconstructed gauges in the panel instrument and other received data such GPS, DGPS, AHARS and ADHRS to be described below, and displaying aircraft marks indicating the respective aircrafts positions on the display screen. The GPS, DGPS, AHARS and ADHRS systems are located in the aircraft cockpit are respectively gives the position of the aircraft the direction, and the attitude in which the aircraft is traveling. The data from the GPS, DGPS. AHARS and ADHRS systems may be transmitted directly to the data reconstruction and display system in the GS. Preferably, the digitized data from these systems is multiplexed with the encoded instrument image data and transmitted in a similar manner to that described above.
6) Installing within the aircraft cockpit additional externally-facing camera for taking images corresponding to the pilot's forward field of view outside of the aircraft, such as for example the horizon. Using as an example the OCR technique to identify the position and slope of the horizon line in the image and submitting the results as a numerical value to the GS in a similar manner to that described above for some dial-type instruments. The received data in the GS provide the use in the GS in addition to the instrument panel also the horizon as seen by the pilot.
7) Using in the GS the 3D map of the terrain over which the aircraft is flying, and all the data mentioned above it is possible to match the position the direction and the orientation of the air craft. The computer in the GS can be suitably programmed to construct, from this data, an image of what the pilot may be seeing outside the aircraft, including for example mountains, lakes and other topographical features, and also including all the other aircrafts in its field of view FOV, which are displayed on the screen.

This real time view is particularly adapted for use with an aircraft for the purpose of student training, in particular to provide real-time flight information to an instructor in a ground station, and optionally for assisting the pilot in flight preparation and/or in debriefing the pilot after flight.

8) The instructor in the GS can switch from one air craft to another and to see the image of what each selected pilot may be seeing outside the aircraft, such as the full topographic view and also including all the other aircrafts in their FOV. The view from the cockpit of the selected pilot which is displayed on the screen can be its forward and backward field of view and its instrument panel. Alternatively, several aircrafts can be selected to be displayed on split screen. It might be used for the purpose of student training, in particular to provide real-time flight information to an instructor in a ground station, and optionally for assisting the pilot in flight preparation and/or in debriefing the pilot after flight and to correct any performed errors of the pilot, which may lead to sever accidents as there is no trainer who can correct the mistakes he made. The instructor is able to switch the displayed scene in the GS between the scenes as seen by the pilot from the cockpit to the scene as see from a selected point of view POV above the terrain of the air space under control.
9) Finding a distance between two neighboring aircraft, and determining whether the distance between two aircraft found is shorter than a threshold value preset as a safety distance. It may provide a mark and a warning mark apparently in three dimensions on the display screen when it is determined that the distance between two aircraft found is shorter than the threshold value. Thus the instructor in the ground station, capable of avoiding the occurrence of near miss or collision by predicting whether the protective air space for at least two aircraft flying closer to each other would conflict each other and by issuing a warning if in the affirmative.
10) The system can provide also the vertical distances between two neighboring aircraft, a distance corresponding to an altitude difference between both aircraft on the display screen, and wherein the pilots cannot see each other. Warning mark is provided when it is determined that the vertical distance between two aircraft found is shorter than the threshold value.
11) The data transmitted from the aircraft might be recorded as a numerical data in the GS, which might be used for example by the instructor to reconstruct virtual view of the cockpit window according to the GPS and other data, linked with a 3D map of the terrain covered by the aircraft, and of the panel instruments, enabling the instructor to instruct the pilot, for example, by comparing the actual flight characteristics to those of the planned flight of the aforementioned simulator.
12) In each embodiment, the encoded instrument image data and digitized data from the AHARS. GPS, audio compression module, and so on may be recorded in any suitable digital recording system. The method may further comprise the step of recording said coded data streams in a crash proof device.
13) The integrated data acquisition and display system may optionally be configured to provide an alarm, which may be audio, visual or of any other form, when one or more of the instruments which are being monitored by the system records a reading that is beyond a predetermined threshold, for example when the temperature of a coolant exceeds a safe temperature.
14) In addition to the conventional communication with the control tower the speaker in the cockpit system and in the ground station enable conversion between the pilot and the instructor using the audio signal multiplexed with other digitized signals.
15) The Instructor in the GS receives the following outputs from the system: displays of the terrain of an air space under air traffic control apparently in three dimensions on a display screen, displays aircraft marks at positions on the display screen so as to correspond to the three dimensional positions of the respective aircraft, a synthetic image of the real time state of the aircraft instrument panel, including current values of gauges and digital displays, and state of switches, levers and indicators; Simulated External View, including a synthetic image of the ground as would be seen from the cockpit including the distributed aircrafts in the field of view of the pilot; Video Playback, including a playback of video recorded during a training mission; Debrief Display, including reconstruction of the display produced on the instructor's display during the training mission; Student Pilot's Reconstructed Voice, i.e., the voice of the Student Pilot, reconstructed at the Instructor's station; Ground Auto Warnings, including automatic warnings generated by the instructor's station when the actual flight path significantly deviates from the flight plan, when Aircraft Safety Envelope is exceeded, or when the instructor decides to activate a warning (the warnings are transmitted to the aircraft); Student Pilot's Performance Report, including a report summarizing and grading the Student Pilot's performance

### DETAILED DESCRIPTION OF THE INVENTION

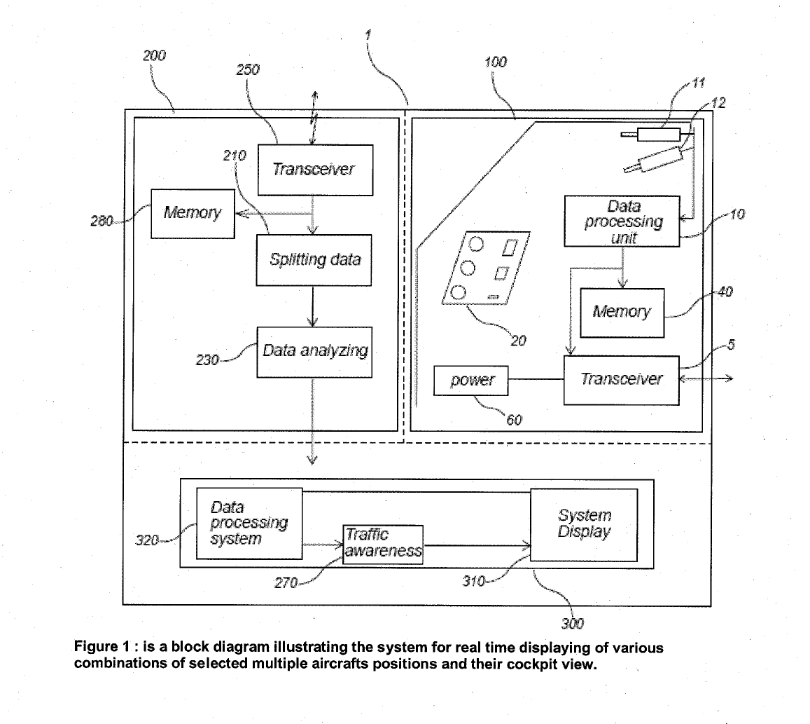

FIG. 1 is a block diagram illustrating the system for real time displaying of various combinations of selected multiple aircrafts positions and their cockpit view 1, using the method according to the present invention, where: the air craft system 100, the GS data processing system 200 and the display system in the GS is 300.

The air craft block shows the data acquisition system 100 comprises at least one camera, as an example two cameras 11 and 12 are illustrated and are connected to a processor unit for data processing 10, a memory 40 and a transceiver 5 based on cellular communication, the system 100 being powered by a suitable power supply 60. Alternatively the transceiver might be RF modem.

The GS data processing system 200 illustrate the general structure of the data reconstruction comprises, a transceiver system 250 for receiving data transmitted from transmitter 5, a processor unit comprising the blocks 210 and 230. The block 210 is a splitting encoded data block providing the encoded data of each aircraft separately and the block 230 is a data analyzing block used for analyzing the data received from 210 of each aircraft. The memory unit 280 provides the flight information to an instructor in a ground station, assisting the pilot in flight preparation and/or in debriefing the pilot after flight.

The data transmitted from the aircraft might be recorded in unit 280 as a numerical data in the GS, which might be used for example by the instructor to reconstruct virtual view of the cockpit window according to the GPS and other data, linked with a 3D map of the terrain covered by the aircraft, and of the panel instruments, enabling the instructor to instruct the pilot, for example, by comparing the actual flight characteristics to those of the planned flight of the aforementioned simulator. In each embodiment, the encoded instrument image data and digitized data from the AHARS, GPS, audio compression module, and so on may be recorded in any suitable digital recording system. The method may further comprise the step of recording said coded data streams in a crash proof device.

The transceiver unit 250 is either a “cellular communication” or a “cellular internet communication”

The display system 300 comprises: data processing system 320, traffic awareness system 270 and display system 310.

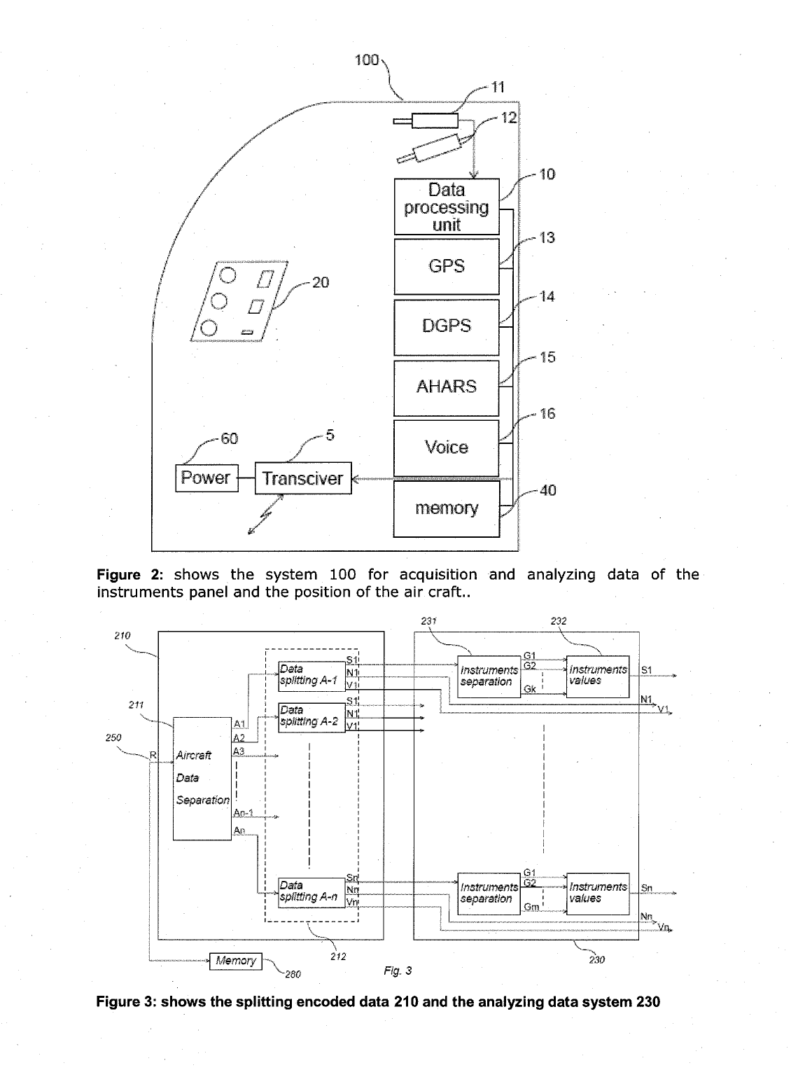

FIG. 2 shows the system 100 for acquisition and analyzing data of the instruments panel and the position of the air craft. The cameras 11 and 12 are located in the cockpit where all the instruments on the whole panel 20 are within the field of view of at least one of the cameras. One of the cameras 11 or 12 may also externally-facing the view outside the aircraft for taking images corresponding to the pilot's forward field of view outside of the aircraft, such as for example the horizon or any impermanent objects.

The cameras 11 and 12 may transfer the digital images to the data processing system 10 via any suitable means known in the art. The data processing system 10 provides the changes in the visual image for an example the angular change in the dial of a dial-type instrument and this angular change is converted to a digital value, for example each datum is represented in 4 bytes (floating point number).

As an example we may implement system 10, using the methods as was described in US-patent 2007/0236366: “[0199] Referring to FIG. 3, the method 300 for acquiring data according to an embodiment of the invention, comprises the steps of:—[0200] Step 310: Procuring at least one image of instrument panel. [0201] Step 320: Dividing image into Regions of Interest (RIO's) for specific instruments, switches etc. being monitored. [0202] Step 330: Providing a computer memory comprising reference datums of ROI's obtained by set-up and calibration of ROI's. [0203] Step 340:

with respect to datums. [0204] Step 350: Providing a list of change values for each ROI. [0205] Step 360: Transforming change values to a coded data stream, e.g., ASCII code. [0206] Step 370: Recording/transmitting series of data, e.g. ASCII data.” Full details description for each of the above mentioned steps 310-370 are given over through the US-patent 2007/0236366 document.

The externally-facing camera let say 12 takes images corresponding to the pilot's forward field of view outside of the aircraft, such as for example: Impermanent objects like cars e.t.c. The horizon, which may be defined in an image as a borderline between two image regions, one corresponding to sky (usually above this border, depending on the attitude of the aircraft), and the other corresponding to ground or sea (typically below). The system 10 may be further adapted for identifying the horizon by applying OCR techniques to an image of the horizon taken by the external camera—basically identifying the position and slope of a line in the image that separates one optical domain, such as “sky” from another, such as “ground” or “sea”. The position of the horizon in the image, and where the “sky” is located with respect thereto in the image may be encoded, for example in a similar manner to that described for some dial-type instruments. US-patent 2007/0236366. This data can be transmitted by the transmitter 5 to the ground station system 200. The transmitter 5 is based on a cellular communication. Alternatively the transmitter 5 might be RF modem.

The data processing system 10 might be based on the processor within the cellular phone.

In addition, the data acquisition system 100 also comprises at least one, and preferably all of the optional features described hereinafter. The GPS system 13 which gives position of the air craft, the DGPS system 14 that gives the direction in which the air craft is travelling and the AHARS module 15 that provides a digital signal representative of the aircraft attitude. The GPS. the DGPS and the AHARS data may be transmitted directly to the GS system 200 or preferably, the digitized data from the GPS or DPGS or the AHARS system is multiplexed with the encoded instrument image data and transmitted (and/or stored) in a similar manner to that described for the encoded instrument image data as describe in US-patent 200710236366. The cockpit computer system samples streaming video and sends numerical data to the GS.

Alternatively, the digitized attitude signal may be routed to the instrument panel and displayed therein, wherein the instrument readout will be enclosed and transmitted with the rest of the data from the instrument panel.

The transmission system 5 is a cellular mean module. Alternatively the transmission system might be RF modem. The transmission system 5 may comprise an audio compression module, adapted for receiving audio 16 input from the cockpit. In this example the pilot's voice and optionally other cockpit sounds, and for digitizing and compressing the audio signal. This compressed audio signal may then be multiplexed with other digitized signals, for example from the AHARS module or GPS/DGPS system, and/or with the encoded instrument image data, and transmitted and/or stored.

FIG. 3 shows the processor unit comprising the splitting encoded data 210 and the analyzing data system 230. The splitting encoded data 210 provide separately the encoded data of each aircraft. The input data R to unit 211 is obtained from the transceiver 250 that collect the data of the aircraft exist in the terrain of an air space under air traffic control. The communication via the cellular to the internet, give the use the ability to monitor flights in any place like home.

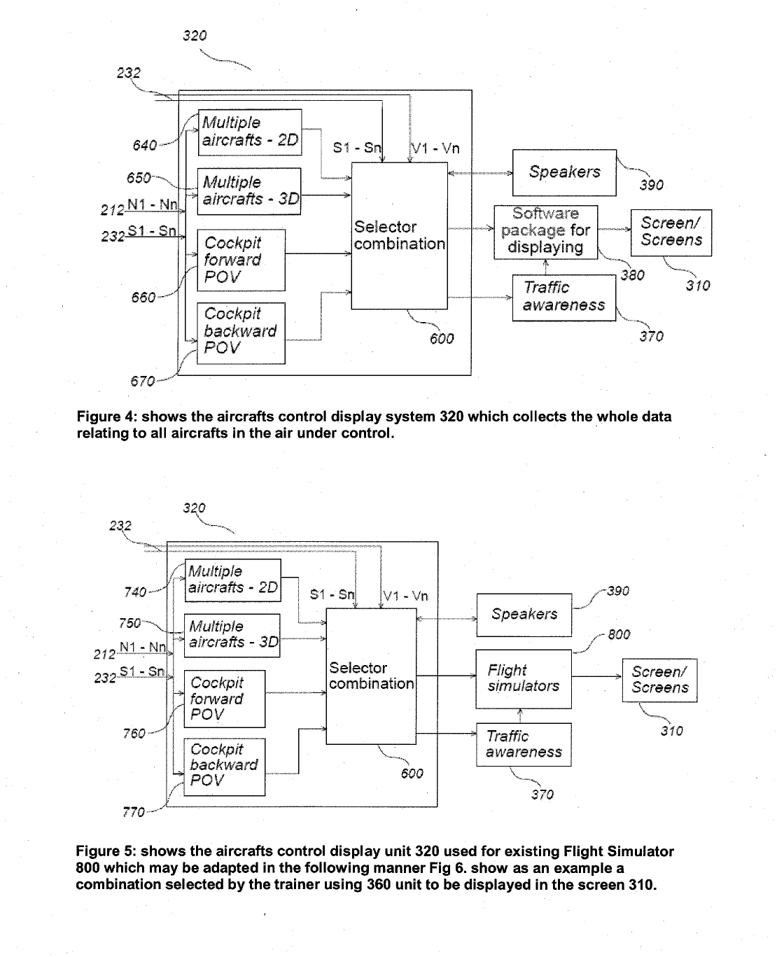

The input data R includes the encoded data of the panel instruments, the audio data and travel information such as: GPS data, DGPS data, the AHARS data of each aircraft. Each air-craft has a unique IP address (ID). Using the IP address in unit 211 the encoded data is separated thus the data of each aircraft, i.e. A1-An, is input separately to unit 212. Unit 212 might be allocated for each individual aircraft. Unit 212 is distinguishing different kinds of data such as: panel instrument data, S, audio data. V, and navigation data, N, such as: GPS data, DGPS data, the AHARS data e.t.c. For the case of n-aircrafts unit 212 provides: Panel data S1-Sn, navigation data N1-Nn and voice data V1-Vn. The navigation data, N, of each aircraft is inputted to unit 320 optional through MUX. The panel instruments data, S; of each aircraft is input separately to unit 231 in the data analyzing system 230, optionally through MUX. The audio data S is inputted to the voice system 390 (FIG. 4) through unit 600. The input data R is saved in memory 280.

The analyzing panel instruments data 230 receiving the panel instruments data S of each specific aircraft S1-Sn, from unit 212 into unit 231 as a series of floating point numbers or other encoded data corresponding to discrete frames originally captured. In system 231 the encoded data is separated for each frame into digital data corresponding to each instrument of the panel G1-Gk, k is the number of instruments in the aircraft under consideration. The data of each panel instrument is inputted to unit 232 for determine the individual value of each instrument. The unit 230 reconstructs in real time the instrument panel of each air craft and provides the instrument panel as input to the unit 320 (FIG. 4).

The instruments data might be input to the navigation units 640-660 in unit 320 (FIG. 4) to be used also as navigation data such as the location and position of the aircraft in addition to the navigation data obtained from unit 212. The navigation data are inputted to units 640-660 for constructing 2D or 3D position of the aircrafts in the air area under the air control.

FIG. 4 shows the aircrafts control display system 320 which collects the whole data relating to all aircrafts in the air under control. The data are received from units 210 (FIG. 3) and 230 (FIG. 3) containing multiple aircrafts current position their travel direction and all other navigation data, N1-Nn, and their real time virtual panels, S1-Sn, and the voice data, V1-Vn. Unit 320 enables the trainer/flight instructor who is not in the aircraft, to monitor the flight at real time—as if he were next to the trainee and to see also the three dimensional positions of the respective aircraft as seen from the cockpit point of view POV 660 and 670 to displays a warning mark when a distance between two aircraft is shorter than a threshold value and give him the needed instructions to overcome problem he might face during flight. Using unit selector combination 600 in 320 the trainer in the GS can select any combination scene from the data in the units 640-670 to be to be input to the “software package for displaying” 380 and displayed on the screen 310. The display screen 310 to be used for displaying the virtual instrument panel and the 3D view of the terrain might be on a single screen or on several display screens. The system enables the trainer to conduct a conversation with a selected pilot.

The navigation unit 600 provides data to the unit 370 for calculating the respective inter distance of aircrafts. So warning is possible by finding an inter-distance between two neighboring aircraft, and determining whether the distance found is shorter than a threshold value and to send a necessary control command in order to effectively avoid the occurrence of near miss or collision.

FIG. 5 shows the aircrafts control display unit 320 used for existing flight simulators 800 which may be adapted in the following manner. The interface of the Flight Simulator 800 enables a user to read and write a set of values to or from the software, the set of values representing parameters such as velocity, altitude etc in appropriate units. In addition the Flight Simulator creates data in the gauges of the virtual control panel. Unit 320 collects the whole data relating to all aircrafts in the air under control. The data are received from units 210 and 230 containing multiple aircrafts current position their travel direction and all other navigation data, N1-Nn, and their real time virtual panels. S1-Sn, and the voice data, V1-Vn. Unit 600 enables the trainer/flight instructor who is not in the aircraft, to monitor the flight at real time—as if he were next to the trainee and to see also the three dimensional positions of the respective aircraft as seen from the cockpit and to displays a warning mark when a distance between two aircraft is shorter than a threshold value and give him the needed instructions to overcome problem he might face during flight. Using unit 320 the trainer/flight instructor in the GS can select any combination of instrument panel, S1-Sn, and scene view from the data in the units 740-770 to be input to the Flight Simulator 800 and to be displayed on the screen 310. The display screen 310 to be used for displaying the virtual instrument panel and the 3D view of the terrain might be on a single screen or on several display screens. The system enables the trainer/flight instructor to conduct a conversation with a selected pilot.

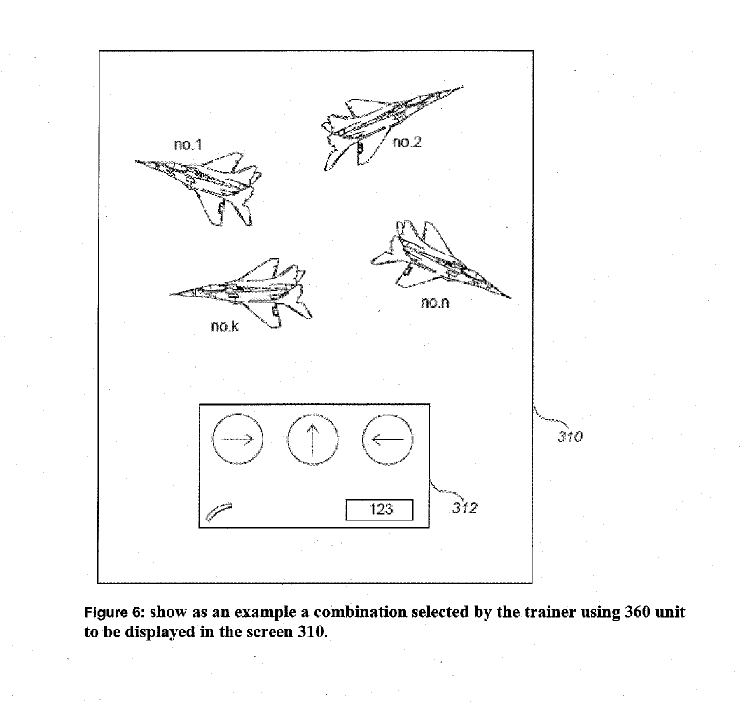

FIG. 6 show as an example a combination selected by the trainer/flight instructor using 600 unit to be displayed in the screen 310. In this combination the aircrafts position, their travel directions and their ground speeds are indicated by vectors based on travel direction data and ground speed data contained in the unit 650 or unit 660. The real time virtual panel 312 of the aircraft number 2, S2 is selected to be displayed in the screen 310. The point of view is determined by the trainer/flight instructor.

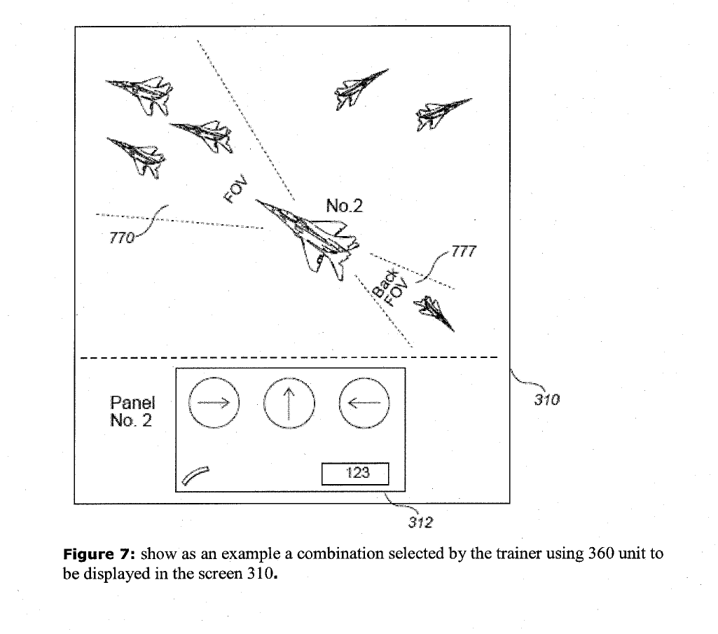

FIG. 7. show as an example a combination selected by the trainer/flight instructor using 600 unit to be displayed in the screen 310. In this combination the trainer/flight instructor in the GS see the same view as the trainee in aircraft number 2 sees including the 3D view of the aircrafts positions as seen within the forward field of view 700 of the trainee in the cockpit. The trainer/flight instructor can select to see the same view as the trainee sees including the 3D view of the aircrafts positions as seen within the backward field of view of the trainee in the cockpit. The trainer/flight instructor can select to see simultaneously the forward field of view and the backward field of view. In this combination the aircrafts of the trainee and those in its field of view presented with their position, their travel directions and their ground speeds and are indicated by vectors based on travel direction data and ground speed data contained in the unit 650 or unit 660. The real time virtual panel 312 of the aircraft number 2, S2, is selected to be displayed in the screen 310. The display screen 310 to be used for displaying the virtual instrument panel and the 3D view of the terrain might be on a single screen or on several display screens.

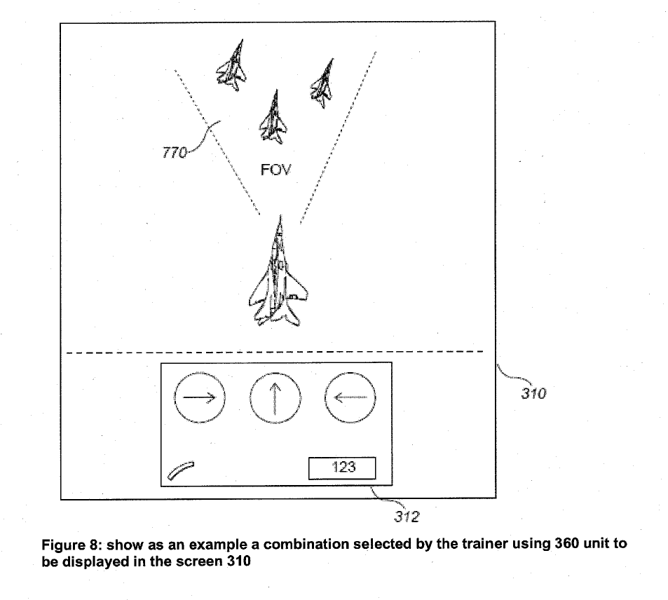

FIG. 8 show as an example a combination selected by the trainer/flight instructor using 600 unit to be displayed in the screen 310. In this combination the trainer/flight instructor in the GS see the same view as the trainee in aircraft number 2 sees including the 3D view of the aircrafts positions as seen within the forward field of view of the trainee in the cockpit. The trainer/flight instructor can select to see simultaneously the forward field of view and the backward field of view. In this combination the aircrafts of the trainee and those in its field of view presented with their position, their travel directions and their ground speeds and are indicated by vectors based on travel direction data and ground speed data contained in the unit 650 or unit 660. The real time virtual panel of the aircraft number 2, S2, is selected to be displayed in the screen 310. The display screen 310 to be used for displaying the virtual instrument panel and the 3D view of the terrain might be on a single screen or on several display screens.

1. A system for real time displaying in a ground station of instruments panel real time data and position of the relevant aircrafts comprising of a cockpit system and ground station;
(A) wherein the cockpit system comprising:
(a) at least one camera for acquiring the data from the instruments panel;
(b) a data processing unit providing a coded data stream representing of said parameter value of the instruments panel;
(c) a cellular means for transmitting the encoded data of the instruments panel and the navigation data such as GPS;
(B) wherein the ground station comprising:
(a) a transceiver for receiving the coded data stream from the cockpit system wherein the transceiver is a cellular transceiver means or internet communication system which connecting the cellular means of the cockpit system to the ground station system via internet connection;
(b) a digital processor unit for a data analyzing and processing providing separately the encoded data of each aircraft, in the terrain of an air space under air traffic control;
(c) a software package for display; the instrumental panel of the air-craft, the terrain as it is being seen by the pilot, 2D maps including flight paths, the radio frequencies and all other information which may interest the pilot;
(d) a display screen;
whereby: the digital processor unit is analyzing and processing the data received from the cockpit system providing the encoded data of each aircraft separately and analyzing the data received from each aircraft for reconstructing a virtual instruments panel of each selected aircraft and the position of the aircrafts in the terrain of an air space under air traffic control and using a “software package for displaying” it to see the instruments panel as seen by the trainee in the cockpit and to see the topographic view and the positions of the respective aircraft as seen by the trainee from the cockpit, where the software package may be an of the shelf such as a flight simulator.

2. A method according to claim 1, further comprising
a memory unit either in the cockpit system or in the ground station;
whereby the memory unit provides the flight information to an instructor in a ground station, assisting the pilot in flight preparation and/or in debriefing the pilot after flight and recording said coded data streams in a crash proof device.

3. A method according to claim 1, further comprising:
a voice system in the cockpit system and in the ground station;
whereby the speaker in the cockpit system and in the ground station enable conversion between the pilot and the instructor using the audio signal multiplexed with other digitized signals.

4. A method according to claim 1 for providing an encoded data stream representative of said parameter value acquired from an instrument panel comprising;
a data processing system based on the cellular data processing system for analyzing said image to provide a measure of said instrument status.

5. A method according to claim 1 of processing in the ground station an encoded data of the flight information, comprising:
a computer with a transceiver wherein the transceiver is one of (a) a cellular transceiver mean; (b) an internet communication system connecting the cellular transceiver on the aircraft to the ground station system via the internet connection where the ground station can be everywhere the internet is available;
receiving through a transceiver an encoded data of the aircrafts in the air space under air traffic control;
a processor unit configured to identify the aircrafts in the air space under air traffic control and to provide a list of the aircrafts with an identification number for each of the aircraft;
a processor unit configured to select one or more aircraft from a list of aircrafts in the air space under air traffic control, as selected by a flight instructor in the ground station;

6. A method according to claim 1, wherein said the encoded data from one or more aircraft, includes at least any one of airspeed, altitude, pitch, roll, yaw, turn rate, vertical speed, horizontal situation (compass heading), engine rpm, oil status, fuel status, oil temperature, Mach number, chronological time;
separating the encoded data of each aircraft.

7. A method according to claim 3, further comprising the step of providing at least one of: attitude data, GPS data, DGPS data, AHARS data, altitude data, voice data;
separating the encoded data of each aircraft.

8. A method according to claim 4 and claim 5 for displaying aircraft positions from predetermined point of view, comprising:
a terrain apparently in three dimensions on a display screen based on topographic data corresponding to an air space under air traffic control;
process for finding three-dimensional positions of respective aircraft based on position data and altitude data of the respective aircraft contained in the air traffic control information obtained about the air space under air traffic control, and
displaying aircraft marks indicating the respective aircraft at positions on the display screen so as to correspond to the three-dimensional positions of the respective aircrafts.

9. The method of claim 6, further comprising the step of providing a display of at least one of a virtual instrument panel of a selected aircrafts by the flight instructor in the ground station;
displaying the virtual instrument panel simultaneously with displaying three-dimensional positions of respective aircrafts, on the same display screen or on an additional display screen.

10. The method of claim 6, further comprising the step of providing a display of at least one of a virtual instrument panel of a selected aircrafts by the flight instructor in the ground station;
Process for providing possible displaying of selected aircrafts and selected panel instruments by the flight instructor in the ground state at least one of the following combination:
(a) displaying the virtual instrument panel simultaneously with displaying three-dimensional view as the trainee in the selected aircraft sees including the 3D view of the aircrafts positions as seen within the forward field of view of the trainee in the cockpit;
(b) displaying the virtual instrument panel simultaneously with displaying three-dimensional view as the trainee in the selected aircraft sees including the 3D view of the aircrafts positions as seen within the backward field of view of the trainee in the cockpit;
(c) displaying the virtual instrument panel simultaneously with displaying three-dimensional view as the trainee in the selected aircraft sees including the 3D view of the aircrafts positions as seen within the forward field of view and the backward field of view of the trainee in the cockpit.

11. A method according to claim 5 for displaying aircrafts positions and virtual instrument panels in any combination that could be switched by the trainer between the combination in claim 6 or in claim 7 or in claim 8 and other possible combinations.

12. A method according to claim 9 for finding a distance between two neighboring aircraft, and determining whether the distance between the two neighboring aircraft is shorter than a safety distance and to provide warning remark on the display screen or by other remark such as sound.

13. A method according to claim 9, further comprising the step of providing a voice communication with at least one of a selected aircrafts by the flight instructor in the ground station.
